(19) United States
(12) Patent Application Publication
(10) Pub. No.: US 2026/0001372 A1
(43) Pub. Date: Jan. 1, 2026

(54) Multi-Part Rail Wheel and Wheel Set for a Rail Vehicle, in Particular a Low-Floor Rail Vehicle

(71) Applicant: Bochumer Verein Verkehrstechnik GmbH, Bochum (DE)

(72) Inventor: Franz Murawa, Bochum (DE)

(21) Appl. No.: 18/879,052

(22) PCT Filed: Jun. 1, 2023
(86) PCT No.: PCT/EP2023/064628

§ 371 Date: Dec. 26, 2024

(30) Foreign Application Priority Data
Jun. 28, 2022 (DE) 10 2022 116 085.8

(51) Int. Cl. B60B 17/00

(52) U.S. Cl. CPC B60B 17/0006; B60B 2310/621; B60B 2360/104

(57) ABSTRACT

A multi-part rail wheel having a wheel tire is presented and described, having a wheel body which consists of a light alloy material and has a hub opening in which a contact surface is provided, on which an outer ring of a roller bearing is supported during use or which is connected to the outer surface of a shaft or a shaft stub during use, and having at least one resilient body which is arranged between the wheel tire and the wheel body and via which the wheel tire is resiliently supported on the wheel body. In order to achieve a good corrosion resistance, a high resistance to mechanical influence and to avoid electrical damage in the wheel bearing, it is proposed that at least the contact surface in the hub opening of the wheel body be covered with an electrically insulating oxide layer (OX) generated by electrochemical anodizing. A wheel set for a rail vehicle, having such rail wheels, is also presented and described.

### CROSS-REFERENCE TO RELATED APPLICATIONS

This application is the United States national phase of International Patent Application No. PCT/EP2023/064628, filed Jun. 1, 2023, and claims priority to German Patent Application No. 10 2022 116 085.8, filed Jun. 28, 2022, the disclosures of which are hereby incorporated by reference in their entireties.

### BACKGROUND OF THE INVENTION

### Field of the Invention

The invention relates to a multi-part rail wheel having a wheel tire, having a wheel body which consists of a light alloy material and has a hub opening in which a contact surface is provided, on which an outer ring of a roller bearing is supported during use or which is connected to the outer surface of a shaft or a shaft stub during use, and having at least one resilient body which is arranged between the wheel tire and the wheel body and via which the wheel tire is resiliently supported on the wheel body.

### Description of the Related Art

Such rail wheels composed of several components are also referred to in the technical terminology as “hybrid rail wheels”, and are used in particular on so-called “inverted portal axles” for low-floor vehicles such as trams or metropolitan railways. Examples of such rail wheels are presented on the applicant's website at the URL https://www.bochumer-verein.de/das-superleichte-bvv-hybridrad-mit-aluminium-felge-zweiteilig/and at the URL https://www.bochumer-verein.de/das-superleichte-bvv-hybridrad-mit-aluminium-felge-dreiteilig/, date found in each case 17, Nov. 2021, and are described in detail for example in WO 2018/046745 A1.

The invention also relates to a wheel set for a rail vehicle, for example for a low-floor rail vehicle, which is equipped with such rail wheels.

Examples of wheel sets for low-floor vehicles fitted with rail wheels of the type presented here in floating bearing are presented at the URL https://www.bochumer-verein.de/de-bvv-niederflur-radsaetze-mit-losradlagerung/, date found 9 Nov. 2021.

In the case of floating wheels of low-floor wheel sets, the floating bearing entails special requirements for the configuration of the opening of the hub which receives the wheel bearing. A brake disc, on which a braking device held on the respective vehicle acts, may in this case additionally be fastened on the rail wheel in question, or the relevant wheel is coupled to a drive in order to transfer drive energy directly to the wheel during vehicle operation. This fastening of a brake disc or of components required for coupling to the drive represents a significant problem in practice for a hybrid rail wheel in which the wheel body is made from a light alloy material, in particular an aluminium material, due to the significantly lower fatigue strength properties of the materials used.

Rail wheels of the type described here may be used not only for low-floor wheel sets, but also for conventional wheel sets or for special designs such as independent wheel suspensions.

Unless otherwise specified, all the mechanical properties specified in the present text for the materials which may be used to manufacture rail wheels according to the invention were determined according to DIN EN 13262 and the FKM Guideline “Calculated Strength Verification of Machine Components”.

In general, the wheel bodies of rubber-sprung rail wheels are manufactured from high-strength steel alloys such as 42CrMo4, 34CrNiMo6 or 30CrNiMo8 according to DIN EN ISO 683, which, with the usual roughnesses of the component surfaces, have a permissible endurance strength of 206 Mpa, 225 Mpa or even 244 Mpa under the safety requirements applicable to rail vehicles.

If however the wheel bodies are made from high-strength aluminium wrought alloys which have a sufficient corrosion resistance, such as the aluminium materials known under the EN material number EN-AW 6082 or under the EN material number EN-AW 6110A according to DIN EN 13981-4, only endurance strengths of typically from 3 5 to 55 Mpa are available. In order nevertheless to enable permanently secure clamping of the resilient bodies between the wheel tire consisting of steel and the wheel body formed from light alloy material, a hybrid wheel has been proposed in the aforementioned WO 2018/046745 A1 in which a counter bearing is provided, which is shrunk in, pressed in or adhesively shrunk on the inner side of the wheel body and consists of a higher-strength material, in particular a steel, against which the clamping takes place. Such a counter bearing may also be used for fastening the brake disc or drive coupling by means of a suitable screw fastening and makes it possible, for example, to provide a wheel body consisting of one of the aluminium wrought alloys mentioned above with the larger stressed cross sections required so that the cyclic stresses occurring during use in the wheel body lie within the permissible range of the material used.

Practical testing has shown that despite the measures explained above, hybrid rail wheels are subject to impermissible wear, particularly in the region of the hub opening of their wheel body which (in the case of a floating wheel bearing) receives the roller bearings required for the rotatable mounting of the wheel on the respectively assigned axle journal.

### SUMMARY OF THE INVENTION

Against this background, the object is to provide a rail wheel which reliably fulfils the requirements placed on its wear resistance.

Furthermore, a wheel set for a rail vehicle, in particular for a low-floor vehicle, which has an optimised service life is intended to be provided.

In relation to the rail wheel, the invention has achieved this object in that such a rail wheel has at least the features as described herein.

In relation to the wheel set, the invention has achieved the object mentioned above in that such a wheel set is fitted with rail wheels configured according to the invention.

Advantageous configurations of the invention are specified in the dependent claims and will be explained in detail below, as will the general concept of the invention.

Accordingly, a multi-part rail wheel according to the invention has, in accordance with the prior art explained in the introduction, a wheel tire (preferably consisting of a wear-resistant steel alloy), a wheel body which consists of a light alloy material and has a hub opening in which a contact surface is provided, on which an outer ring of a roller bearing is supported during use or which is connected to the outer surface of a shaft (for example of a wheel set) or a shaft stub (for example of an independent wheel suspension) during use, and at least one resilient body which is arranged between the wheel tire and the wheel body and via which the wheel tire is resiliently supported on the wheel body. Particularly in the case of a floating wheel bearing, preferably at least two contact surfaces, on which the outer rings of two roller bearings are supported during use, are provided in the hub opening. For use with a rigid wheel set, on the other hand, a single contact surface in the hub opening is sufficient in order to generate a secure connection (in particular a force-or friction-fit connection) between the contact surface and the outer surface of a shaft or a shaft stub. Two or more resilient bodies, via which the wheel tire is resiliently supported on the wheel body, may be arranged between the wheel tire and the wheel body.

According to the invention, at least the contact surface in the hub opening of the wheel body is covered with an oxide layer generated by electrochemical anodizing. If two or more contact surfaces are provided in the hub opening of the wheel body, all the contact surfaces may be covered with an oxide layer generated by electrochemical anodizing.

A wheel set for a rail vehicle comprises according to the invention two rail wheels formed according to the invention, which are connected with their contact surface to the outer surface of a shaft or a shaft stub. The connection is preferably a force-fit or friction-fit connection, which may for example be generated by pressing in and/or shrinking on.

The wheel set may, for example, be a wheel set for a low-floor rail vehicle. A wheel set for a low-floor rail vehicle comprises according to the invention a portal axle which has an axle middle part extending along a longitudinal axis and two axle journals, one of which is seated on a first end section of the axle middle part and a second of which is seated on a second end section of the axle middle part, which is formed opposite to the first end section, the axle journals being aligned facing outwards from the axle middle part, and two rail wheels formed according to the invention, which are rotatably mounted in floating bearing on the axle journal of the portal axle in each case via at least one roller bearing which is seated with an inner ring on the respective axle journal and bears with a circumferential surface of an outer ring on the contact surface, which is provided in the hub opening of the wheel body of the rail wheel.

The invention is based on the discovery that in the case of a hybrid wheel, the wheel body of which consists of a light alloy material and which is to be mounted in floating bearing on an axle of a wheel set for a rail vehicle, additional measures are required in order to avoid interactions between the inner surface of the hub opening of the wheel body and the bearing outer ring of the roller bearings via which the rail wheels are mounted on the axle journals of the wheel set. These consist according to the invention in the hub opening of the wheel body, which serves to receive the rolling bearing, in particular configured as a roller bearing, being subjected to a special surface treatment, namely electrochemical anodizing.

According to the invention, this treatment, also referred to in the technical terminology as “anodization”, deliberately generates an oxide layer at least on the contact surface which forms a section of the inner surface of the hub opening of the wheel body and which the outer ring of the roller bearing bears during use or which is connected to the outer surface of a shaft or a shaft stub during use, the thickness and density of which layer exceed the thickness and density of the native oxide layer which is naturally formed on the surface of the wheel body as a result of contact between the light alloy material of the wheel body and the surrounding atmosphere.

Surprisingly, it has been found here that merely this oxide layer, which is artificially imposed by a deliberate treatment, is sufficient to increase the wear and abrasion resistance of the contact surface to such an extent that the requirements placed on the service life of the rail wheel are reliably achieved.

This is also contributed to by the fact that the oxide layer provided according to the invention ensures a high corrosion resistance in the region of the contact between the wheel body consisting of light alloy and the outer ring of the roller bearing, which generally consists of a roller bearing steel known for this purpose, or the material of the outer surface of the shaft or the shaft stub.

A further advantage of the oxide layer generated by electrochemical anodizing according to the invention at least in the region of the contact surfaces provided in the bearing opening of the wheel body for the respective roller bearing, or provided for the shaft or the shaft stump is that the oxide layer acts as an electrically insulating barrier layer. In this way, it prevents an unintended flow of current—for example from the wheel body via the wheel bearing to the axle stub—and thereby reliably prevents the occurrence of bearing damage which could otherwise be induced by a flow of current.

Typically, rail wheels of the type according to the invention—when they are used in a floating wheel bearing-are mounted via two roller bearings, such as ball bearings, on the axle journal assigned to them. In this case, which is important in practice, there are therefore two contact surfaces in the bearing opening, which are covered in the manner according to the invention with an oxide layer generated by electrochemical anodizing.

The resistance of a rail wheel according to the invention may be further improved when used in a floating wheel bearing not only by the contact surface assigned to the respective roller bearing being covered with an oxide layer according to the invention, but also when the contact surface forms a section of an inner surface of the hub opening of the wheel body and the inner surface of the hub opening is covered entirely with the oxide layer generated by electrochemical anodizing.

In this case, it has proven to be particularly advantageous when the wheel body is also covered on its free outer side outside the hub opening at least in sections with the oxide layer formed according to the invention by electrochemical anodizing. This has the advantage that the outer side of the wheel body, which is exposed to the weather, also has a high corrosion resistance and at the same time an increased resistance of the surface to mechanical attacks which may occur during use, for example due to ballast pick-up during vehicle operation. The resistance to corrosion and mechanical damage achieved by the oxide layer produced according to the invention is so high that additional measures such as coating may be obviated. In this way, the necessary elaborate inspections of the integrity of coated rail wheels and any required corrective maintenance work may be reduced to a minimum.

In order to make the fullest use of the advantages of the oxide layer provided according to the invention, the wheel body may be covered entirely with the electrochemically generated oxide layer.

In order to clamp the resilient body between the wheel tire and the wheel body, a clamping means clamped against the wheel body may be provided in a manner known per se (see WO 2018/046745 A1). This is typically configured as a clamping ring which is seated on a suitable circumferential heel of the wheel body.

If the optionally present clamping element of a rail wheel according to the invention is also to be provided with an optimised stability and corrosion resistance, this may also be achieved in that the clamping element is covered at least in sections with an oxide layer generated by electrochemical anodizing. Here, it has proven to be particularly expedient that the clamping element is covered with an oxide layer generated by electrochemical anodizing at least in the region of its surface that comes in contact with the resilient body.

In the event that a connecting zone for connecting an electrically conductive cable connection (“current bridge”) is provided on the outer surface of the wheel body and/or of the optionally present clamping means, the outer surface of the wheel body, of the wheel tire and/or of the optionally present clamping element with the exception of the connecting zone may be covered with the oxide layer generated by electrochemical anodizing. The respective connecting zone should be excluded from the oxide layer in order to ensure a minimised electrical junction resistance between the connected cable and the component, “wheel body” or “clamping element”, to which the electrically conductive cable connection is respectively connected.

Methods for controlled electrochemical anodizing are sufficiently known to the person skilled in the art. In the event that the wheel body consists of an aluminium material, as is preferred by the invention, it is possible to reinforce the naturally present oxide layer by 50 to 5000 times with the known anodizing methods. Typically, the thickness of the oxide layer thus generated and provided according to the invention is from 10 μm to 160 μm, in particular from 30 μm to 140 μm.

For the electrochemical generation of the oxide layer provided according to the invention, the wheel body to be treated is put into a bath consisting of an electrically conductive liquid, the electrolyte, and is connected to a direct voltage source so that it acts as an anode in the electrochemical process. Typically, sulfuric acid or oxalic acid is used as the electrolyte. In addition, an e.g. rod-shaped cathode, which typically consists of stainless steel, lead or aluminium, is immersed in the electrolyte bath. In the voltage field formed in this way, anions containing oxygen are formed with the release of hydrogen at the cathode and migrate to the surface of the wheel body. There, they react with the aluminium material of the wheel body so that an aluminium oxide layer which adheres firmly to the free surfaces of the wheel body is created. The oxide layer formed in this way comprises a thin so-called barrier layer, which is almost pore-free, fully sealed and electrically insulating, and a significantly thicker, slightly porous and electrically conductive top layer which has been formed by a chemical reaction of the barrier layer with the electrolyte. Surfaces of the wheel body that are to remain free from the oxide layer may be masked in a known manner, for example by means of a coating known for this purpose from the prior art. Further explanations of known methods for electrochemical anodizing of a light alloy material, which are suitable for the purposes according to the invention, may be found in Galvanotechnik by Nasser Kanani; Hanser-Verlag, Munich; 3rd Edition 2020.

The invention proves particularly advantageous when the wheel body of a rail wheel according to the invention consists of an aluminium material, in particular an aluminium wrought alloy of the type mentioned in the introduction. In this configuration, the oxide layer generated by electrochemical anodizing consists of at least 87.1% by mass Al₂O₃ and a remainder of other oxides, which are formed in the course of electrochemical anodizing from oxide-forming alloy constituents that are contained in addition to aluminium in the aluminium material of the wheel body. Maximised Al₂O₃ contents in this case prove particularly advantageous with a view to optimising the resistance. According to one advantageous configuration of the invention, therefore, the oxide layer generated by electrochemical anodizing consists of at least 95.0% by mass Al₂O₃.

A wheel set according to the invention for a rail vehicle comprises two rail wheels formed according to the invention, which are preferably connected with their contact surface to the outer surface of a shaft or of a single wheel which is connected to a shaft stub, for example by means of a force-or friction-fit connection.

A wheel set according to the invention for a low-floor rail vehicle comprises
a portal axle, which has an axle middle part extending along a longitudinal axis and two axle journals, one of which is seated on a first end section of the axle middle part and a second of which is seated on a second end section of the axle middle part, which is formed opposite to the first end section, the axle journals being aligned facing outwards from the axle middle part, and
two rail wheels formed according to one of the preceding claims, which are rotatably mounted in floating bearing on the axle journal of the portal axle in each case via at least one roller bearing which is seated with an inner ring on the respective axle journal and bears with a circumferential surface of an outer ring on the contact surface, which is provided in the hub opening of the wheel body of the rail wheel, two roller bearings respectively being provided for each of the rail wheels in practice.

### BRIEF DESCRIPTION OF THE DRAWINGS

The terms Fig., Figs., Figure, and Figures are used interchangeably in the specification to refer to the corresponding figures in the drawings.

The invention is explained in more detail below on the basis of a drawing representing an exemplary embodiment. The schematic drawings show the following:

FIG. 1 a rail wheel mounted on an axle journal provided at an end section of a portal axle in a section along the section line A-A indicated in FIG. 2;

FIG. 2 the rail wheel in a front view directed at its free front side facing away from the portal axle;

FIG. 3 a wheel body of the rail wheel shown in FIGS. 1 and 2 in a sectional representation corresponding to one of FIGS. 1.

### DESCRIPTION OF THE INVENTION

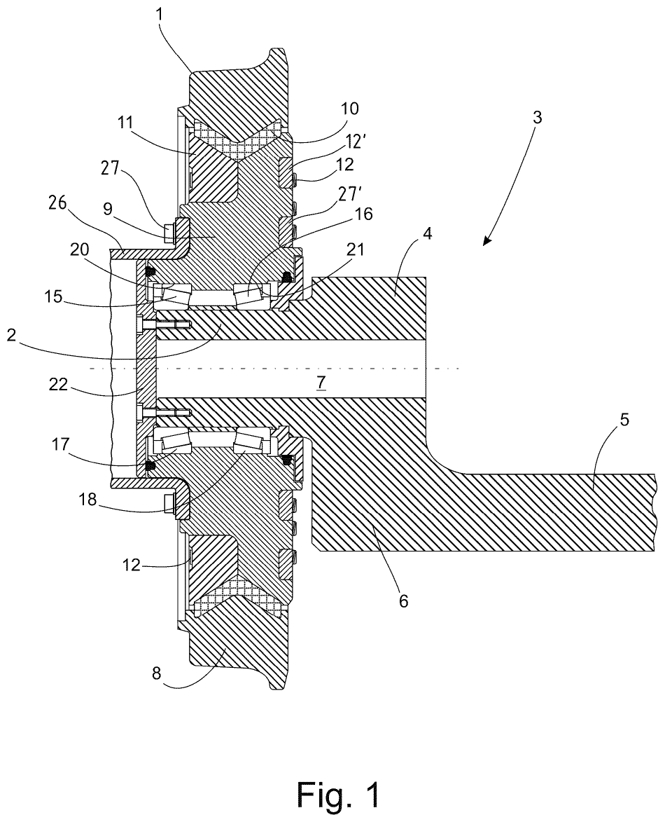

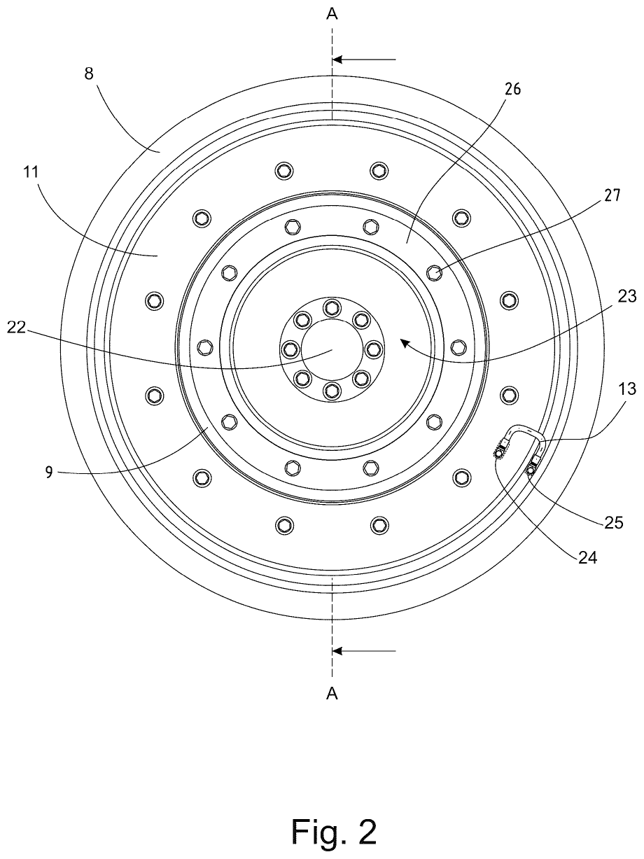

FIGS. 1 and 2 represent a rail wheel 1 which is rotatably mounted on an axle journal 2 of a portal axle 3. As an alternative thereto, rail wheel 1-not rotatable-may be connected to a shaft or a shaft stub. The axle stub 2 is formed in one piece on a flange 4, which in turn is formed in one piece on an axle middle part 5 of the portal axle 3, in such a way that the flange 4 stands on an end section 6 assigned thereto of the axle middle part 5 and the axle stub 2 is carried by the flange 4 while facing laterally away from the axle middle part 5. In order to minimise the weight of the portal axle 3, a through-opening 7, which leads from the free front side of the axle stub 2 to the side surface, assigned to the axle middle part 5, of the flange 4 is introduced into the axle stub 2.

The portal axle 3 comprises a second arrangement, consisting of a flange and an axle journal, which is formed in the same way and on which a rail wheel (not shown here) formed in accordance with the rail wheel 1 is mounted. In relation to the middle of the portal axle 3, this second arrangement is provided mirror-symmetrically with respect to the arrangement formed from the flange 4 and the axle journal 2 with the rail wheel 1 on an end section (also not shown here) of the axle middle part 5, which is formed at opposite the end of the axle middle part 5 from the first end section 6.

The rail wheel 1, the portal axle 3 and the second rail wheel mounted thereon are part of a wheel set, which may in the conventional way have further components or devices. These include, for example, a braking device for braking the rail wheels, a drive device for driving the rail wheels and/or a spring-damper system via which the wheel set can be coupled spring-resiliently in a known manner to a chassis of a low-floor rail vehicle, such as a tram. In this respect, FIG. 1 and FIG. 2 only shown by way of example a connecting element 26, which is intended to receive a braking device (in particular a brake disc) or a drive device and is fastened on the wheel body 9 in the region of a connecting zone via clamping screws 27, which are screwed into counter bearings 27′.

The rail wheel 1 represented here as an example of the rail wheels of the wheel set is, in a manner known from the prior art explained in the introduction of this text, composed in multiple parts of a wheel tire 8, a wheel body 9 and resilient bodies 10, which are arranged at regular intervals between the wheel tire 8 and the wheel body 9 and via which the wheel tire 8 is resiliently supported on the wheel body 9.

In order to clamp the resilient bodies 10 between the wheel tire 8 and the wheel body 9, a clamping ring 11 is provided which is fastened on the wheel body 9 in the manner described for example in WO 2018/046745 A1 by means of clamping screws 12, which are screwed into counter bearings 12′.

The wheel body 9 is electrically conductively connected to the clamping ring 11 via the clamping screws 12 and the corresponding counter bearings 12′. The electrical connection between the wheel tire 8 and the wheel body 9 is established in the manner described, for example, in WO 2020/234286 A1 via a current bridge 13, which bears with the cable lug provided at one of its ends in a first connecting zone 25 on the front face of the wheel tire 8 facing away from the portal axle 3 and with the cable lug provided at its other end in a second connecting zone 24 on the free front face of the clamping ring 11. As an alternative thereto, the second connecting zone 24 of the cable lug may bear on free front side of the wheel body 9.

The wheel body 9 is made from an aluminium material, for example from the aluminium wrought alloy standardised under the EN material number EN-AW 6082, and has a hub opening 14 through which the axle journal 2, assigned to the rail wheel 1, of the portal axle 3 is guided.

Two roller bearings 15, 16 formed as ball bearings, the outer rings 17, 18 of which each bear on a contact surface 20, 21 provided on the inner surface 19 of the hub opening 14, are seated in a known manner on the axle stub 2 in a floating bearing arrangement. The contact surfaces 20, 21 each occupy a section of the inner surface 19 of the hub opening 14. The position of the roller bearings 15, 16 on the axle stub 2 is secured via a cover 22 screwed onto the front side of the axle stub 2.

Before assembling the rail wheel 1, the wheel body 9 consisting of the aluminium material was subjected to electrochemical anodizing, which was carried out in the manner known per se already explained above. By the anodizing, an oxide layer OX with a thickness of 10 μm to 160 μm, consisting of at least 87.1% by mass Al₂O₃, was generated on the entire outer surface 23 of the wheel body 9, the inner surface 19 of its hub opening 14 and in particular the contact surfaces 20, 21.

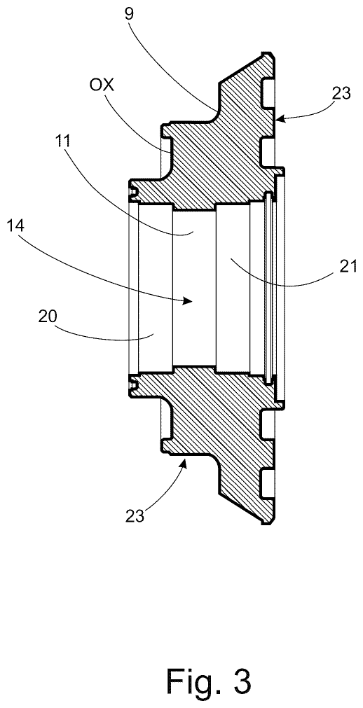

As indicated in FIG. 3 by the contour line of the wheel body 9 depicted with a larger line thickness, the oxide layer OX covers the outer surfaces 23 of the wheel body 9 and the inner surface 19 of its inner opening 14 with the contact surfaces 20, 21 fully tightly in the technical sense, except for connecting surfaces for so-called grounding contacts with which the electrical connection is established between the chassis of the rail vehicle and via the current bridges 13 with the wheel tires 8, and therefore with the rail. As such, the oxide layer OX forms not only an optimally resistant protection against corrosion and abrasive wear but also, particularly in the region of the contact surfaces 20, 21, an electrical insulation by which a flow of current from the axle stub 2 via the roller bearings 16, 17 to the wheel body 8 and vice versa is prevented. In order to ensure an optimal electrical junction between the clamping ring 11 and the wheel body 8, the surfaces in which contact occurs between the clamping screws provided for holding the clamping ring 11 on the wheel body 9 and the wheel body 9, as well as the connection points of the grounding contacts on the wheel body 9, may be covered by applying a covering agent known for this purpose from the prior art, for example a suitable coating, in order to avoid the creation of the oxide layer OX there.

Optionally, the clamping ring 11 may also be provided with an oxide layer generated by electrochemical anodizing order to optimise its resistance to mechanical attacks, for example stone chipping. For this purpose, the clamping ring 11 is electrochemically provided with the oxide layer in a manner known per se before the rail wheel 1 is assembled. Before the electrochemical treatment, the connecting zones 24 on the clamping ring 11, in which the cable lugs of the current bridge 13 bear on the front faces of the clamping ring 11, are covered with a suitable covering agent, for example a coating usual for this purpose in the prior art. In this way, the connecting surfaces are kept free from the oxide layer and an optimal electrical junction between the current bridge 13, the wheel tire 8, the clamping ring 11 and concomitantly the wheel body 9 is ensured. If, as an alternative thereto, the connecting zone 24 is positioned not on the clamping ring 11 but directly on the wheel body 9, similar covering of this zone takes place in order to achieve an optimal electrical junction. The same procedure is also adopted with the connection points for the aforementioned grounding contacts on the wheel body.

### LIST OF REFERENCES

1 rail wheel
2 axle journal
3 portal axle
4 flange of portal axle 3
5 axle middle part of portal axle 3
6 end section of the axle middle part of the portal axle 3
7 through-opening of the axle stub 2
8 wheel tire
9 wheel body
10 resilient body
11 clamping ring
12 clamping screws
12′: counter bearing (of the clamping screw 12)
13 current bridge
14 hub opening of the wheel body 8
15,16 roller bearing
17.18 outer rings of the roller bearings 15, 16
19 inner surface of the hub opening 14
20,21 contact surfaces for the outer rings 17, 18 of the roller bearings 15, 16
22 cover
23 outer surface of the wheel body 9
24, 25 connecting zones for the current bridge 13
26 connecting element
27 clamping screw
27′ counter bearing (of the clamping screw 27)
OX oxide layer

1. A multi-part rail wheel having a wheel tire, having a wheel body which consists of a light alloy material and has a hub opening in which a contact surface is provided, on which an outer ring of a roller bearing is supported during use or which is connected to the outer surface of a shaft or a shaft stub during use, and having at least one resilient body which is arranged between the wheel tire and the wheel body and via which the wheel tire is resiliently supported on the wheel body, wherein at least the contact surface in the hub opening of the wheel body is covered with an oxide layer (OX) generated by electrochemical anodizing.

2. A wheel according to claim 1, wherein the contact surface forms a section of an inner surface of the hub opening of the wheel body and in that the inner surface of the hub opening is covered entirely with the oxide layer (OX) generated by electrochemical anodizing.

3. The rail wheel according to claim 1, wherein at least a section of an outer surface of the wheel body is also covered with the oxide layer (OX) generated by electrochemical anodizing.

4. The rail wheel according to claim 1, wherein a clamping means, which consists of a light alloy material and is clamped against the wheel body, is provided in order to clamp the resilient body between the wheel tire and the wheel body.

5. The rail wheel according to claim 4, wherein the clamping means is covered with an oxide layer (OX) generated by electrochemical anodizing at least in the region of its surface that comes in contact with the resilient body.

6. The rail wheel according to claim 3, wherein a connecting zone for connecting an electrically conductive cable connection is provided on the outer surface of the wheel body and/or the outer surface of the clamping means and in that the respective outer surface with the exception of the connecting zone is fully covered with the oxide layer (OX) generated by electrochemical anodizing.

7. The rail wheel according to claim 1, wherein the thickness of the oxide layer (OX) respectively present is from 10 μm to 160 μm.

8. The rail wheel according to claim 1, wherein the wheel body consists of an aluminium material and the oxide layer (OX) generated by electrochemical anodizing consists of at least 87.1% by mass Al₂O₃ and a remainder of other oxides, which are formed in the course of electrochemical anodizing from oxide-forming alloy constituents that are contained in addition to aluminium in the aluminium material of the wheel body.

9. A wheel set for a rail vehicle, having two rail wheels formed according to claim 1.

10. The wheel set according to claim 9, wherein the rail wheels are connected with their contact surface to the outer surface of a shaft or a shaft stub.

11. The wheel set according to claim 9 for a low-floor rail vehicle, having a portal axle, having an axle middle part extending along a longitudinal axis and two axle journals, one of which is seated on a first end section of the axle middle part and a second of which is seated on a second end section of the axle middle part, which is formed opposite to the first end section, the axle journals being aligned facing outwards from the axle middle part, and having two rail wheels formed according to one of the preceding claims, which are rotatably mounted in floating bearing on the axle journal of the portal axle in each case via at least one roller bearing which is seated with an inner ring on the respective axle journal and bears with a circumferential surface of an outer ring on the contact surface, which is provided in the hub opening of the wheel body of the rail wheel

12. The wheel set according to claim 11, wherein the rail wheels are in each case rotatably mounted on their assigned axle journal of the portal axle by means of two roller bearings and in that a contact surface in the hub opening of the wheel body of the rail wheels is assigned to each roller bearing.
